(19) United States
(12) Patent Application Publication
(10) Pub. No.: US 2013/0290054 A1
(43) Pub. Date: Oct. 31, 2013

(54) METHOD OF MEASURING PROGRESS OF CONSTRUCTION WORK PROCESS USING MOTION SENSOR

(71) Applicant: MYONGJI UNIVERSITY INDUSTRY AND ACADEMIA COOPERATION FOUNDATION, Gyeonggi-do (KR)

(72) Inventors: Youngsoo JUNG, Gyeonggi-do (KR); Jiwon Ha, Gyeonggi-do (KR); Taehwan JU, Jeollanam-do (KR)

(73) Assignee: MYONGJI UNIVERSITY INDUSTRY AND ACADEMIA COOPERATION FOUNDATION, Gyeonggi-do (KR)

(21) Appl. No.: 13/743,950

(22) Filed: Jan. 17, 2013

(30) Foreign Application Priority Data
Apr. 30, 2012 (KR) 10-2012-0045214

(51) Int. Cl. G06Q 50/08

(52) U.S. Cl. CPC G06Q 50/08; G06Q 10/063114
USPC 705/7.15

(57) ABSTRACT

The present invention relates to a method of measuring progress of a construction work process using a motion sensor. A reception unit of a management server receives data about expected engaged workers for different processes, for different days, and for different floors. A control unit of the management server arranges the received data into DBs in such a way as to store the data about the expected engaged workers for different processes, for different days, and for different floors in a process-based engaged worker DB, a day-based engaged worker DB, and a floor-based engaged worker DB of a DB unit, respectively. The control unit creates an expected work schedule using the stored data. A communication unit of the management server receives data actually collected via the motion sensor. The control unit measures progress of work by comparing the actually collected data with the expected work schedule.

### CROSS-REFERENCE TO RELATED APPLICATIONS

The present application claims priority under 35 U.S.C. 119 to Korean Patent Application No. 10-2012-0045214, filed on Apr. 30, 2012, the disclosure of which is expressly incorporated by reference herein in its entirety.

### STATEMENT REGARDING SPONSORED RESEARCH

This inventions was made with Korean governments support under Automated Progress Measurement and Management for Construction Projects (Grant No. 2009-0074881) awarded by National Research Foundation of Korea and Development of Modernized HANOK technology (Grant No. 2012-0300) awarded by Korea Institute of Construction & Transportation Technology Evaluation and Planning. The Korean governments have certain rights in the invention.

### BACKGROUND OF THE INVENTION

1. Field of the Invention

The present invention relates, in general, to a method of measuring the progress of a construction work process using a motion sensor and, more particularly, to a method of measuring the progress of a construction work process using a motion sensor, which collects data, such as the entry/exit information of workers for respective floors in the entire process of a construction work site, by utilizing a motion sensor, thus enabling the current progress and process condition of construction to be determined by comparing and analyzing the patterns of engaged workers.

2. Description of the Related Art

Generally, systems or methods for measuring in real time the progress of construction work based on the progress of construction after the construction has started in a construction site have been used only in a partial process. However, there are few or no systems or methods for measuring the entire progress of construction work in real time. Therefore, since the progress of construction work is not separately measured, a probable cost is exceeded or a construction period is extended, thus causing considerable construction cost.

Further, the following Patent document 1 relates to a system and method for simulating the current progress condition of construction in three dimensions. This patent provides a system and method for simulating the current progress condition of construction in three dimensions, which represent the current progress condition of construction in three dimensions in order to meet the requirement of drawings of current construction progress condition that can manifestly represent various types of information so that any of various users, such as workers directly related to construction, normal users indirectly related to construction, and persons working in public relations with construction, can intuitively and easily determine the current progress condition of construction, thus enabling various types of information to be displayed on a single screen so that the various types of information can be clearly and easily recognized.

However, the above-described Patent document 1 enables the degree of the progress of construction to be determined using only three-dimensional (3D) drawings by combining the appearance of a building under construction with geographical information, but is problematic in that it is impossible to determine the degree of the progress of a work process based on labor workers actually engaged in construction work for respective floors in terms of exact construction expenses corresponding to the amount of work completed.

### PRIOR ART DOCUMENT

### Patent Document

(Patent document 0001) Patent document: Korean Patent No. 10-0844467 (Jul. 1, 2008)

### SUMMARY OF THE INVENTION

Accordingly, the present invention has been made keeping in mind the above problems occurring in the prior art, and an object of the present invention is to provide a method of measuring the progress of a construction work process using a motion sensor, which collects data, such as the entry/exit information of workers for respective floors, by utilizing a motion sensor in the entire process of a construction work site, thus enabling the current progress and process condition of construction to be determined by comparing and analyzing the patterns of engaged workers.

In order to accomplish the above object, the present invention provides a method of measuring progress of a construction work process using a motion sensor, the method being performed by a system including a management server, a communication network, and at least one motion sensor, including a reception unit of the management server receiving data about expected engaged workers for different processes, for different days, and for different floors, input through an input unit, a control unit of the management server arranging the received data into databases (DBs) in such a way as to store the data about the expected engaged workers for different processes, for different days, and for different floors in a process-based engaged worker DB, a day-based engaged worker DB, and a floor-based engaged worker DB of a DB unit, respectively, the control unit creating an expected work schedule using the data stored in the DB unit, a communication unit of the management server receiving data actually collected via the motion sensor, and the control unit measuring progress of work by comparing the actually collected data with the expected work schedule and patterns of engaged workers. In this case, the control unit may measure progress of a work process based on a difference between a number of expected engaged workers for different processes, for different days, and for different floors and a number of actual workers sensed by the motion sensor. In greater detail, the control unit may determine that the progress of the work process is slower if a number of actual workers sensed by the motion sensor is greater than a number of expected engaged workers for a corresponding day, for a corresponding floor, or for a corresponding process, and may determine that the progress of the work process is faster if a number of actual workers sensed by the motion sensor is less than a number of expected engaged workers for a corresponding day.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a system for measuring the progress of a construction work process using a motion sensor according to the present invention;

FIG. 2 is a flowchart showing a method of measuring the progress of a construction work process using a motion sensor according to the present invention;

FIG. 3 is a graph showing a work process expected by the method of measuring the progress of a construction work process using a motion sensor according to the present invention;

FIG. 4 is a flowchart showing the data reception step of the method of measuring the progress of a construction work process using a motion sensor according to the present invention; and

FIG. 5 is a flowchart showing the work schedule creation step of the method of measuring the progress of a construction work process using a motion sensor according to the present invention.

### DESCRIPTION OF THE PREFERRED EMBODIMENTS

Hereinafter, embodiments of the present invention will be described in detail with reference to the attached drawings. The terms and words used in the present specification and the accompanying claims should not be limitedly interpreted as having their common meanings or those found in dictionaries. Therefore, the embodiments described in the present specification and constructions shown in the drawings are only the most preferable embodiments of the present invention, and are not representative of the entire technical spirit of the present invention. Accordingly, it should be understood that various equivalents and modifications capable of replacing the embodiments and constructions of the present invention might be present at the time at which the present invention was filed.

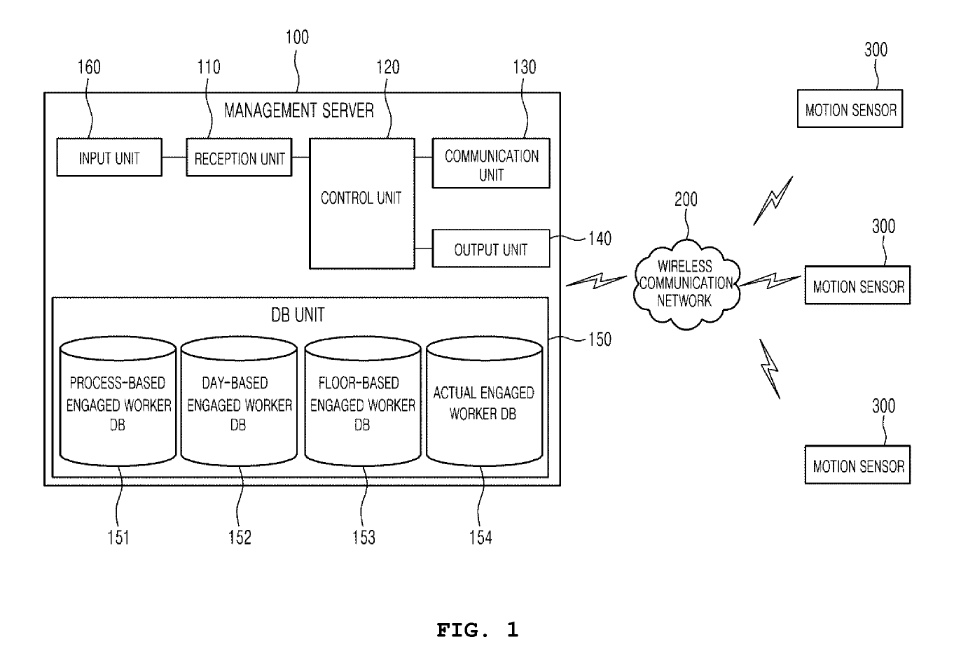

FIG. 1 is a diagram showing a system for measuring the progress of a construction work process using a motion sensor according to the present invention.

As shown in FIG. 1, a system for measuring the progress of a construction work process using a motion sensor according to the present invention includes a management server 100, a wireless communication network 200, and motion sensors 300.

The management server 100 receives various types of data and measures the progress rate of a construction work process via comparison and analysis with received signals.

Each of the motion sensors 300 is installed at the main entrance of a floor on which work is carried out, and is configured to count the number of workers passing through the corresponding floor.

The wireless communication network 200 functions to transfer data between the management server 100 and the motion sensors 300 installed in a construction site.

The management server 100 will be described in detail below. The management server 100 includes a reception unit 110, a control unit 120, a communication unit 130, an output unit 140, a database (DB) unit 150, and an input unit 160.

The input unit 160 is a means used to allow the manager of the management server 100 according to the present invention to input various types of data, wherein the manager defines a work list for floors of a building, work characteristics for respective floors, Data Acquisition Technology (DAT) characteristics, and a repetitive process list, and inputs the lists and the characteristics.

Meanwhile, the reception unit 110 receives various types of data input through the input unit 160, and the control unit 120 arranges the received data into a DB by storing the received data in the DB unit 150.

The communication unit 130 receives the number of workers sensed and counted by each motion sensor 300 while communicating with the motion sensor 300.

The output unit 140 outputs the results of determination of the progress rate of work, obtained when the control unit 120 compares the number of workers received by the communication unit 130 with the data input and stored by the manager and then determines the progress rate of the work, to a display unit or the like.

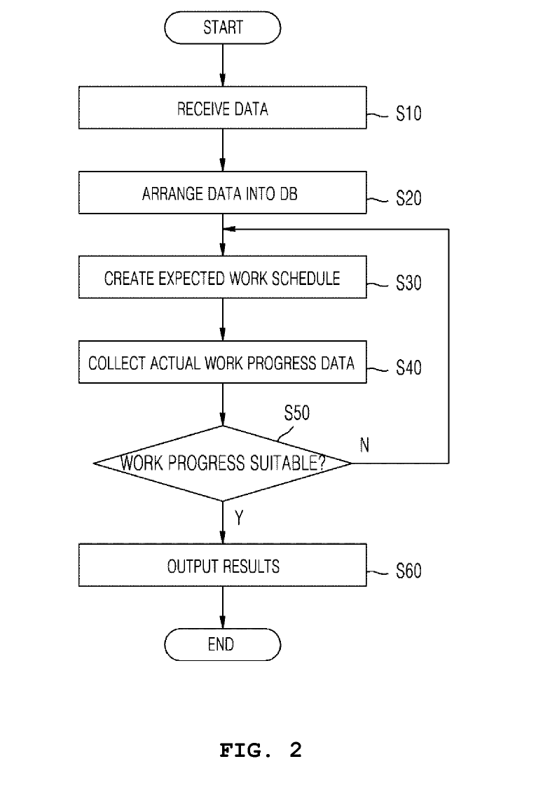

Below, a method of measuring the progress of a construction work process using a motion sensor according to the present invention through the above-described configuration will be described in detail with reference to FIG. 2.

For reference, FIG. 2 is a flowchart showing a method of measuring the progress of a construction work process using a motion sensor according to the present invention.

As shown in FIG. 2, the reception unit 110 performs the step S10 of receiving data about engaged workers for different processes, engaged workers for different days, and engaged workers for different floors, which have been input through the input unit 160.

The control unit 120 performs the step S20 of arranging the received data into DBs in such a way as to store the data about the engaged workers for different processes, the data about the engaged workers for different days, and the data about the engaged workers for different floors, in a process-based engaged worker DB 151, a day-based engaged worker DB 152, and a floor-based engaged worker DB 153, respectively.

The control unit 120 performs the step S30 of creating an expected work schedule using the data arranged into the DBs.

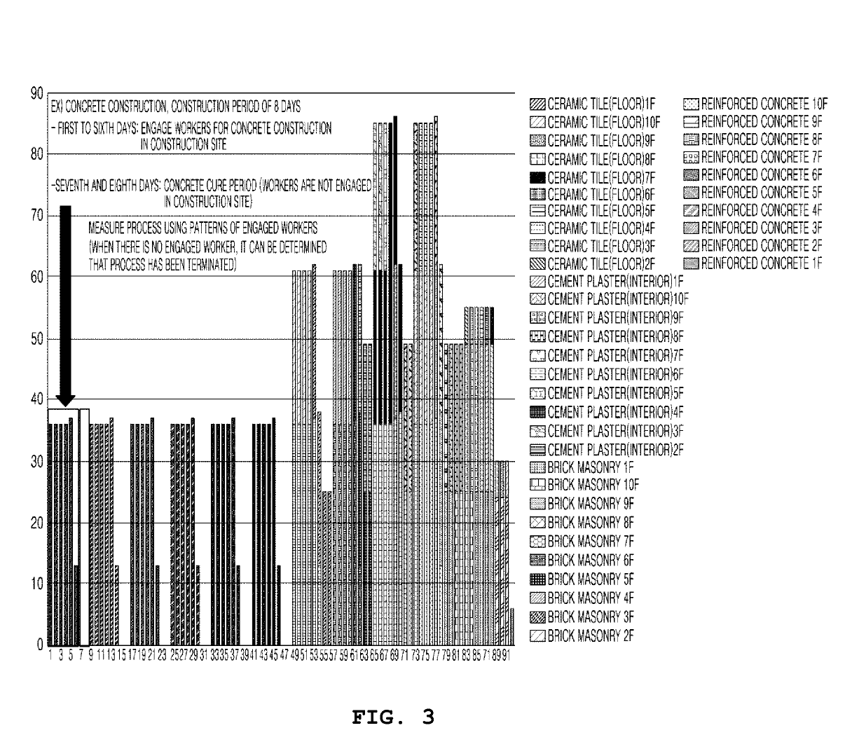

Below, the expected work schedule creation step S30 will be described in detail with reference to FIG. 3.

FIG. 3 is a diagram showing a schedule for the pattern comparison of engaged workers using the sum of the numbers of engaged workers for different processes and for different days.

As shown in FIG. 3, in a construction process, an expected work schedule related to concrete construction is created at step S30 as follows. That is, a construction period required for concrete construction corresponding to one floor is a period of a total of eight days, wherein workers for installing reinforcing bars, installing a molding flask, and depositing concrete are engaged in a construction site during a term from first to sixth days, and wherein workers will not be engaged in the construction site during a term corresponding to seventh and eighth days because, during this term, a concreted surface is cured.

Further, it can be seen in FIG. 3 that the work schedule has been fixed such that 35 to 40 workers are expected to be engaged in the construction site during the term ranging from first to fifth days, and 10 to 15 workers are expected to be engaged in the construction site on the sixth day.

Thereafter, the communication unit 130 performs the step S40 of collecting actual data via the motion sensors 300 installed in the construction site.

That is, when each motion sensor 300 senses workers who enter and leave the construction site on respective days, and counts the number of workers actually engaged in the construction site, the communication unit 130 collects information about the counted number of actual engaged workers. The control unit 120 stores the data collected by the communication unit 130 in the actual engaged worker DB 154 of the DB unit 150.

Thereafter, the control unit 120 performs the step S50 of comparing the data collected by the communication unit 130 with the expected work schedule created at step S30 and then determines whether the progress of the work is suitable.

That is, when, in the period of eight days in which concrete construction is carried out, the motion sensor 300 senses the motions of a number of workers corresponding to the designated number of workers during the term ranging from first to fifth days according to the expected work schedule, the control unit 120 determines that the progress of the work is smoothly made according to the expected work schedule. Further, when, on the sixth day on which a number of workers that are equal to or more than 10 workers and are equal to or fewer than 15 workers are expected to be engaged in the construction site, the motion sensor 300 does not sense the motions of the corresponding number of workers, the control unit 120 determines that the progress of the work is made faster than that of the expected work schedule.

The term corresponding to seventh and eighth days is a term during which the deposited concrete is cured, so that no workers must be engaged in the construction site. However, if the motion of any worker is sensed by the motion sensor 300, the control unit 120 determines that the concrete construction is being delayed from that of the expected work schedule.

If it is determined at step S50 that the progress of the work is smoothly made according to the expected schedule, the output unit 140 performs the step S60 of outputting the results of the determination.

In contrast, if it is determined at step S50 that the progress of the work is not smoothly made, it is preferable to revise the created work schedule and perform again the procedure subsequent to step S30.

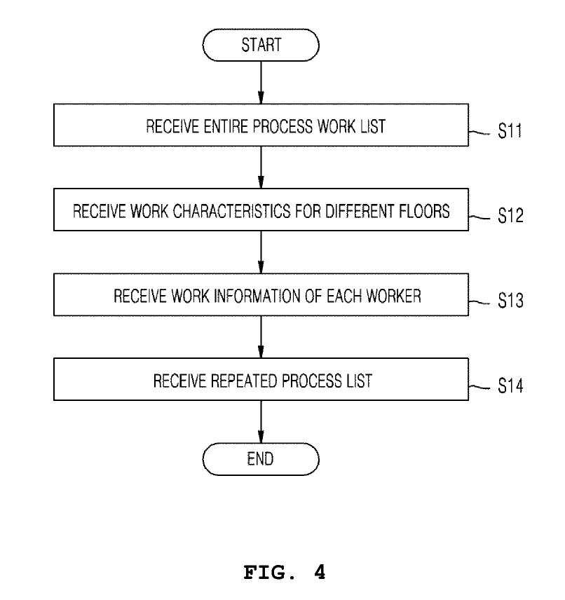

The step where the reception unit 110 receives data about engaged workers for different processes, engaged workers for different days, and engaged workers for different floors, will be described in detail below with reference to FIG. 4.

FIG. 4 is a flowchart showing the data reception step of the method of measuring the progress of a construction work process using a motion sensor according to the present invention.

First, the reception unit 110 performs the step S11 of receiving an entire process work list required to construct a building, and performs the step S12 of receiving characteristics of work for different floors, such as times required for work for different floors contained in the entire process work list.

Thereafter, the reception unit 110 performs the step S13 of receiving information, such as the importance of work of each worker assigned to each floor, and equipment and materials assigned to each floor, and performs the step S14 of receiving the characteristic list of the process repeated on each floor.

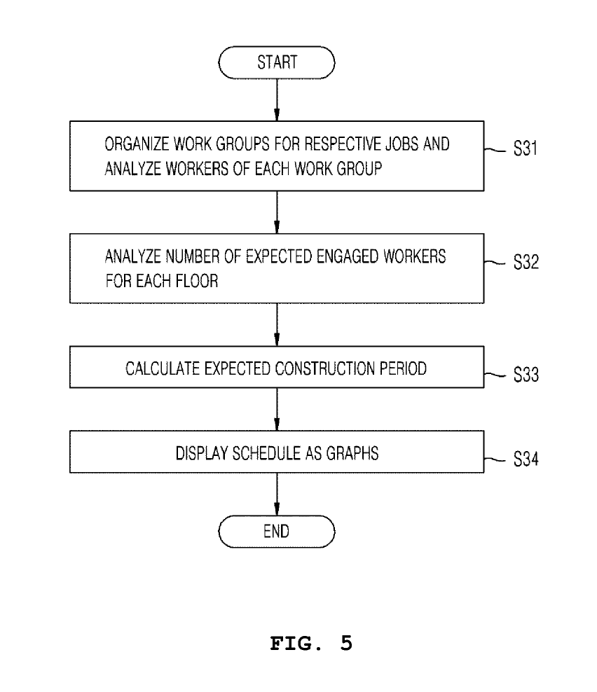

The step S30 of creating the expected work schedule using the data received at step S10 and the data arranged into DBs at step S20 will be described in greater detail below with reference to FIG. 5.

FIG. 5 is a flowchart showing the work schedule creation step of the method of measuring the progress of a construction work process using a motion sensor according to the present invention.

The control unit 120 performs the step S31 of organizing work groups to be engaged in respective jobs in the entire process work list, and analyzing workers of the work groups together with pieces of equipment of the work groups.

The control unit 120 performs the step S32 of analyzing the number of engaged workers of each work group, organized at step S31, for different processes, for different days, and for different floors.

The control unit 120 performs the step S33 of calculating an expected construction period depending on the number of engaged workers for different processes, for different days, and for different floors, analyzed at step S32.

The control unit 120 outputs the step S34 of producing a construction period schedule based on the number of engaged workers for different processes, for different days, and for different floors at step S33, as graphs having various forms and providing the graphs.

Further, the step where the communication unit 130 collects actual data via the motion sensors 300 installed in the construction site will be described in detail.

The motion sensors 300 are installed at the entrances of respective floors and are configured to perform the step of collecting information about the number of workers actually engaged in the construction site and sensed by the motion sensors 300.

Each of the motion sensors 300 performs the step of transmitting the collected information to the communication unit 130 of the management server 100 via the communication network 200.

As described above, the present invention provides a method of measuring the progress of a construction work process using a motion sensor, which collects data, such as the entry/exit information of workers for respective floors, by utilizing a motion sensor in the entire process of a construction work site, so that the current progress and process condition of construction can be determined by comparing and analyzing the patterns of engaged workers. Accordingly, the present invention is advantageous in that when the current progress of construction is slower than that of scheduled progress, measures for coping with the speed of the progress can be prepared for, and in that data, such as the degree of progress of work and caused cost based on the number of workers, can be utilized as reference data for subsequent construction.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of measuring progress of a construction work process using a motion sensor, the method being performed by a system including a management server, a communication network, and at least one motion sensor, comprising:
(A) a reception unit of the management server receiving data about expected engaged workers for different processes, for different days, and for different floors, input through an input unit;
(B) a control unit of the management server arranging the received data into databases (DBs) in such a way as to store the data about the expected engaged workers for different processes, for different days, and for different floors in a process-based engaged worker DB, a day-based engaged worker DB, and a floor-based engaged worker DB of a DB unit, respectively;
(C) the control unit creating an expected work schedule using the data stored in the DB unit;
(D) a communication unit of the management server receiving data actually collected via the motion sensor; and
(E) the control unit measuring progress of work by comparing the data actually collected at (D) with the expected work schedule created at (C) and patterns of engaged workers.

2. The method of claim 1, wherein (E) is configured such that the control unit measures progress of a work process based on a difference between a number of expected engaged workers for different processes, for different days, and for different floors and a number of actual workers sensed by the motion sensor.

3. The method of claim 2, wherein:
the control unit determines that the progress of the work process is slower if a number of actual workers sensed by the motion sensor is greater than a number of expected engaged workers for a corresponding day, for a corresponding floor, or for a corresponding process, and
the control unit determines that the progress of the work process is faster if a number of actual workers sensed by the motion sensor is less than a number of expected engaged workers for a corresponding day.

4. The method of claim 3, further comprising (F) an output unit outputting results of determination if it is determined at (E) by the control unit that the progress of the work process is smoothly made according to the expected work schedule.

5. The method of claim 3, wherein if it is determined at (E) by the control unit that the progress of the work process is not smoothly made according to the expected work schedule, the management server revises the created work schedule and performs again a procedure subsequent to (C).

6. The method of claim 3, wherein (A) comprises:
(A-1) the reception unit receiving an entire process work list;
(A-2) receiving information about time required for each floor in the entire process work list;
(A-3) receiving information about importance of jobs of workers assigned to each floor and pieces of equipment and materials assigned to each floor; and
(A-4) receiving a characteristic list of a process repeated on each floor.

7. The method of claim 3, wherein (C) comprises:
(C-1) the control unit organizing work groups to be engaged in respective jobs in the entire process work list, and analyzing workers of the work groups together with pieces of equipment of the work groups;
(C-2) the control unit analyzing a number of engaged workers of each work group, organized at (C-1), for different processes, for different days, and for different floors;
(C-3) the control unit calculating an expected construction period depending on the number of engaged workers for different processes, for different days, and for different floors analyzed at (C-2); and
(C-4) producing a construction period schedule based on the number of engaged workers for different processes, for different days, and for different floors at (C-3) in a form of a plurality of graphs and providing the graphs.
